(19) United States
(12) Patent Application Publication
(10) Pub. No.: US 2011/0253405 A1
(43) Pub. Date: Oct. 20, 2011

(54) Oscillating power tool

(76) Inventors: Zhiguo Chen, Nanjing (CN); Jiyu Zhang, Nanjing (CN); Baijun Zhang, Nanjing (CN)

(21) Appl. No.: 12/798,997

(22) Filed: Apr. 15, 2010

(51) Int. Cl. B25F 5/00

(52) U.S. Cl. 173/213

(57) ABSTRACT

An oscillating power tool comprises a motor and an oscillating driving shaft driven by the motor. The driving shaft has a longitudinal axis and a free end. The free end has a flange. The flange of the free end has a securing section on one face. The securing section comprises at least two protrusions which are independent from each other. Each protrusion has at least three tips. As a result of this arrangement, a working tool may be fixed securely and reliably to the driving shaft of the oscillating power tool.

### TECHNICAL FIELD

The present invention relates to an oscillating power tool, and more particularly, to a driving shaft of a oscillating power tool.

### BACKGROUND OF THE INVENTION

An oscillating power tool generally comprises a motor and a driving shaft driven by the motor. The driving shaft moves in an oscillatory manner. A working tool, such as a blade or a sanding plate, can be attached to the driving shaft and can move with the driving shaft to cut or grind a workpiece.

Because the driving shaft of the oscillating power tool oscillates continuously during operation, the working tool attached to the driving shaft may loosen during operation. When the working tool loosens, the power tool does not operate effectively. It is also possible that the working tool may become detached and injure either the user or a bystander. Accordingly, for an oscillating power tool, the connection of the working tool to the driving shaft is very important. However, the traditionally implemented single screw coupling is unable to connect the working tool to the driving shaft in a reliable manner.

To address the above problem, the prior art provided a driving shaft with several circular or rectangular protrusions on one end face. Correspondingly, the working tool was provided with several recesses which would engage the protrusions on the driving shaft. As a result, the working tool could be connected to the driving shaft through the engagement of the recesses and the protrusions. This design also required a bolt to secure the working tool to the driving shaft. If a bolt was not used, it was possible that the working tool could have different angular positions due to the arrangement of the protrusions on the driving shaft.

Further, the prior art design did not allow for a compact or smaller design to be incorporated into a portable power tool. As power tools have evolved, each part of the power tool has continued to become smaller. Due to the shrinking size of portable power tools, the circular or rectangular protrusions on the driving shaft have also been made smaller. As a result of the smaller size of the protrusions, the protrusions have become difficult to mold and manufacture. And as a result, the protrusions have become weaker, and are easier to break when they engage the recesses of the working tool due to the torsional force of the oscillating driving shaft.

### SUMMARY OF THE INVENTION

An object of the invention is to provide an improved oscillating power tool. The oscillating power tool comprises a motor and an oscillating driving shaft driven by the motor. The driving shaft comprises a longitudinal axis and a free end. The free end of the driving shaft has a flange. The flange has a securing section on one face. The securing section of the flange comprises at least two protrusions which are independent from each other. Each protrusion has at least three tips.

Further, in the present invention, each protrusion on the driving shaft has at least three tips, which provides increased strength when compared to the protrusions of the prior art. As a result of the increased strength, the working tool of the present invention may be securely positioned on the driving shaft. Further, the protrusions of the present invention are easier to mold and manufacture than the protrusions of the prior art. Further, as an additional benefit, due to the arrangement of the protrusions of the present invention, more working tools in the market can be adapted to be used in the oscillating power tool.

### BRIEF DESCRIPTION OF THE DRAWINGS

The present invention will become apparent from the following detailed description of the preferred embodiment of the invention illustrated in the accompanying drawings, wherein:

FIG. 1 is a perspective view of an oscillating power tool of a first embodiment of the present invention;

FIG. 2 is a perspective view of a driving shaft of the oscillating power tool shown in FIG. 1;

FIG. 3 is an end view of the driving shaft shown in FIG. 2;

FIG. 4 is a perspective view of the driving shaft of another embodiment of the present invention; and,

FIG. 5 is an end view of the driving shaft shown in FIG. 4.

### DETAILED DESCRIPTION

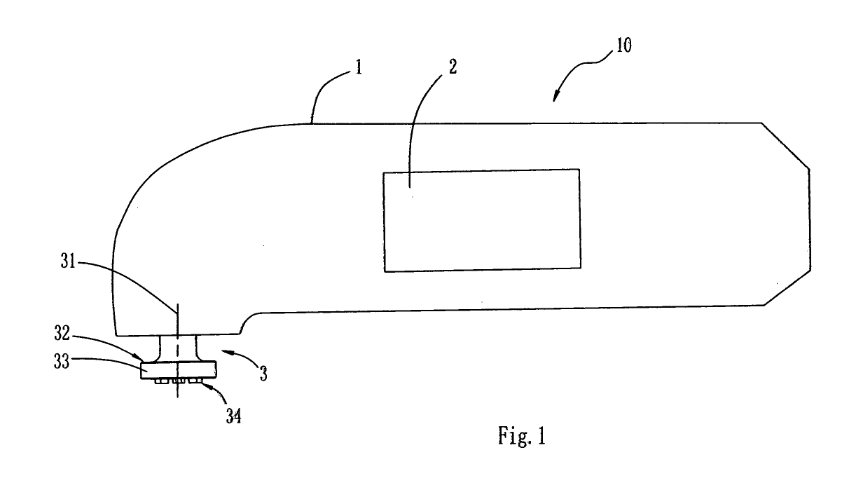

As shown in FIG. 1, an oscillating power tool 10 comprises a motor 2 within a housing 1. The motor 2 drives a driving shaft to move in an oscillating manner through a transmission mechanism. The driving shaft comprises a longitudinal axis 31 and a free end 32. The free end 32 protrudes out of the housing 1 and has a flange 33. The flange 33 comprises a securing section 34 on one face for securing a working tool such as a blade or a sanding plate.

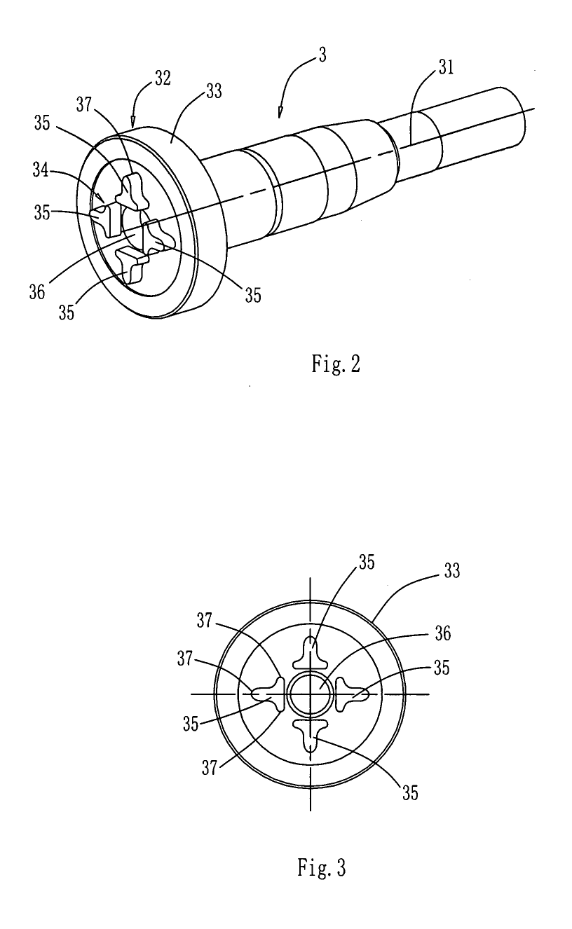

With reference to FIGS. 2 and 3, the securing section 34 comprises four protrusions 35 each of which has a T shape. The four protrusions 35 are independent from each other and surround a central hole 36 of the driving shaft 3. The two adjacent protrusions 35 are spaced at an angle of 90°. Each protrusion 35 has three tips 37. Preferably, the three tips 37 are rounded tips, which are adapted to engage with arcuate recesses on the working tool and can be easily molded and manufactured.

In the current power tool market, the working tool generally has several arcuate recesses or holes. When the working tool is installed in the power tool, the arcuate recesses of the working tool engage with the rounded tips on the flange, thereby securing the position of the working tool in the horizontal direction. A bolt may also be used to engage the working tool with the central hole of the driving shaft which secures the working tool in the vertical direction. As a result, the working tool is tightly secured to the driving shaft.

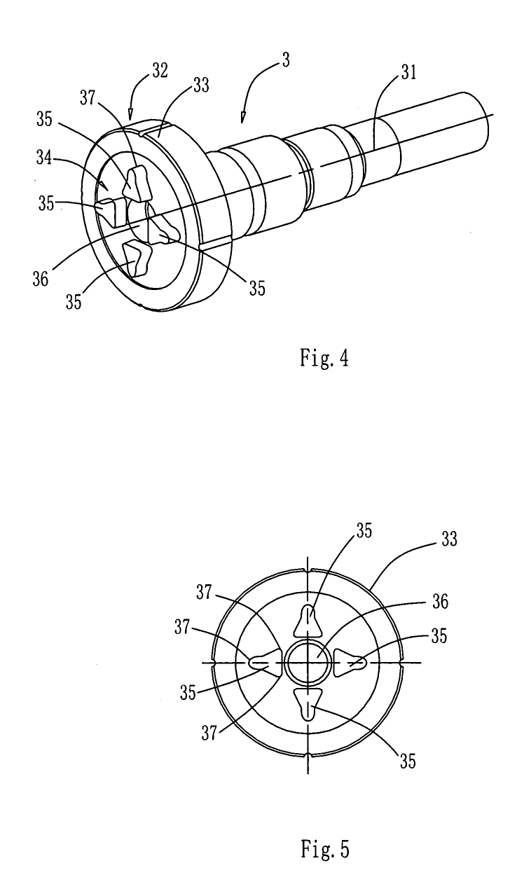

With reference to FIGS. 4 and 5, another embodiment of the present invention is shown. In this embodiment, the securing section 34 comprises four protrusions 35 which are approximately triangular. Each protrusion 35 has three tips 37. Preferably, the three tips 37 are rounded tips. The protrusions of the present embodiment have higher strength than the T-shaped protrusion of the first embodiment discussed previously. As a result, the working tool may be secured more reliably to the driving shaft.

The present invention is not restricted to the embodiments disclosed herein. For example, the securing section of the driving shaft may have fewer than four protrusions. For example, as few as two protrusions may accomplish a secure connection of the working tool to the driving shaft. However, the inclusion of four protrusions in the above embodiments provides the working tool with three different angular mounting positions. Accordingly, any obvious substitutions and modifications according to the spirit of the present invention will be regarded as falling within the claims appended hereto.

1. An oscillating power tool comprising:
a motor;
an oscillating driving shaft driven by the motor; the driving shaft comprising:
a longitudinal axis;
a free end having a flange; and
wherein the flange comprises a securing section for a working tool; and
wherein the securing section comprising at least two independent protrusions to secure the working tool horizontally to the securing section, each protrusion having at least three tips and a triangular shape.

2. The oscillating power tool of claim 1, wherein the tips of the protrusions are rounded tips.

3. The oscillating power tool of claim 2, wherein the securing section comprises four protrusions.

4. The oscillating power tool of claim 3, wherein the two adjacent protrusions are separated by angles of 90°.

5. The oscillating power tool of claim 4, wherein the flange further comprises a central hole, the four protrusions surrounding the central hole.

6. The oscillating power tool of claim 1, wherein each protrusion has a T-shape.

7. (canceled)

8. The oscillating power tool of claim 1, wherein a bolt is used to vertically secure the working tool to the securing section.

9. An oscillating power tool comprising:
a motor;
an oscillating driving shaft driven by the motor; the driving shaft comprising:
a longitudinal axis;
a free end having a flange; and
wherein the flange comprises a securing section for a working tool; and
wherein the securing section comprising at least two independent protrusions to secure the working tool horizontally to the securing section, each protrusion having at least three tips and a T-shape.

10. The oscillating power tool of claim 9, wherein the tips of the protrusions are rounded tips.

11. The oscillating power tool of claim 10, wherein the securing section comprises four protrusions.

12. The oscillating power tool of claim 11, wherein the two adjacent protrusions are separated by angles of 90°.

13. The oscillating power tool of claim 12, wherein the flange further comprises a central hole, the four protrusions surrounding the central hole.

14. The oscillating power tool of claim 9, wherein each protrusion has a triangular shape.

15. The oscillating power tool of claim 9, wherein a bolt is used to vertically secure the working tool to the securing section.

16. An oscillating power tool comprising:
a motor;
an oscillating driving shaft driven by the motor; the driving shaft comprising:
a longitudinal axis;
a free end having a flange; and
wherein the flange comprises a securing section for a working tool; and
wherein the securing section comprising four independent protrusions to secure the working tool horizontally to the securing section, each protrusion having at least three tips and at least one of a triangular shape or a T-shape; and
wherein the tips of the protrusions are rounded tips; and
wherein the two adjacent protrusions are separated by angles of 90°; and
wherein the flange further comprises a central hole, the four protrusions surrounding the central hole; and
wherein a bolt is used to vertically secure the working tool to the securing section.
